(19) United States
(12) Patent Application Publication
(10) Pub. No.: US 2012/0229277 A1
(43) Pub. Date: Sep. 13, 2012

(54) MONITORING AND ALERT SYSTEM FOR VENTILATED RACK SYSTEMS

(76) Inventors: George S. Gabriel, Seaford, DE (US); Neil E. Campbell, Eden, MD (US); Edward K. Eldreth, Port Deposit, MD (US); Rodney E. Gerringer, Forest Hill, MD (US); Josh C. Tang, Westford, MA (US); Adam Cohen, Worcester, MA (US); Thomas R. Thibodeau, Milford, MA (US)

(21) Appl. No.: 13/268,292

(22) Filed: Oct. 7, 2011

Related U.S. Application Data
(60) Provisional application No. 61/391,387, filed on Oct. 8, 2010.

(51) Int. Cl. G08B 21/00

(52) U.S. Cl. 340/540

(57) ABSTRACT

The present invention is directed to monitoring/alert systems, devices, and methods useable with animal housing units. Embodiments include a primary component, such as a system controller device, for monitoring maintenance and operational events in a housing unit and a secondary component, such as a environmental monitoring device for analyzing environmental conditions. For example, the system controller device monitors unit functions (e.g., relating to power, pre-filter(s), filter(s), fan(s), air pressure, air temperature, electrical connections, etc.) and causes alert(s) to be sent (e.g., via email or text message) if there is a malfunction or abnormal operational data. The environmental monitoring device collects environmental data (e.g., time, temperature, humidity, light, sound, carbon dioxide levels, or ammonia levels) and causes alert(s) to be sent if an abnormal environmental condition is detected. The primary and secondary components may function in connection with one another, other devices, a network, or as stand-alone devices.

### CROSS REFERENCE TO RELATED APPLICATIONS

This application claims priority to U.S. Provisional Patent Application No. 61/391,387, filed Oct. 8, 2010, entitled MONITORING AND ALERT SYSTEM FOR VENTILATED RACK SYSTEMS, the entire disclosure of which is incorporated herein by reference.

### BACKGROUND OF THE INVENTION

1. Field of the Invention

The embodiments of the present invention relate to monitoring and alert systems, devices, and methods for use with ventilated laboratory rack systems. More specifically, the invention relates to a control unit for use with a ventilated rack system that will alert a user when the alarm is triggered by an event or service is required. The invention further relates to a monitoring unit to monitor environmental conditions in or around the ventilated rack system. The monitoring and alert system preferably enables a user to monitor laboratory equipment from remote locations via an electronic network. For example, the user will preferably be remotely notified of critical service reminders, warnings, and alarms via e-mail, text message, voice message, or any other form of electronic communication or signal.

2. Description of Related Art

Ventilated rack systems, such as, by way of example and without limitation, the products of the RAIR-HD™ or RAIR IsoSystem™ family produced by Lab Products, Inc., are commonly used by laboratories to house research specimens, such as rodents or other animals. The housing system is most often, but not limited to a series of cage-level barrier plastic cages each holding one or more rodents. These plastic cages are located on a rack system that will provide HEPA filtered air delivery individually to each cage. Certain cages also have a system of exhaust air capture which removes the air expelled from the cage and HEPA filters that filter air before delivering the air safely back into the room or facility exhaust system. Each cage works as an isolated cage-level micro-environment allowing multiple studies to be performed on cages housed on the same unit. These units typically utilize complex series of computer controlled fans, pressure sensors, air control devices, filters, fan run hours, etc. Rodents and other such research animals must often be housed in these or similar controlled environments, at times with precise specifications, and necessitate regular maintenance. The rodents or other animals can become quite valuable between the genetic breeding, and valuable research dollars invested into each animal.

Accordingly, it is desirable to provide a system and environment monitoring and alert system for the protection for rodents and other valuable pharmaceutical research animals.

It is also desirable to provide a monitoring system capable of providing accurate reporting methods and records to assist in procuring facility AAALAC and other governing agency accreditations.

It is further desirable to provide a system that can save facility labor hours through reduced cage and equipment inspections.

It should be noted that although the below description describes the systems, devices and methods of the present invention in the context of a monitoring and alert system for ventilated rack systems, it can be appreciated by one of ordinary skill in the art that certain aspects of the present invention can be used in conjunction with other products and applications without departing from the scope of the invention.

### SUMMARY OF THE INVENTION

Preferred embodiments of the present invention provide systems, methods, devices and/or software to monitor, analyze, and/or report the environmental and operational status of a ventilated housing unit, transfer unit, or other laboratory equipment or facility.

Exemplary embodiments of the present invention provide a system and method of real-time monitoring of ventilated housing system, including populated in-cage environmental conditions on and off site, 24 hours a day. The monitoring system can preferably be used to monitor operational status of the units and preferably sends remote (either or both on and off site) warnings and/or alerts to one or more selected users alerting them of particular events, such as unit malfunctions, required service, out of range parameters. or any other predetermined operational function. If a problem occurs within the housing system e.g., fan stops working, power is lost, HEPA filter is blocked etc., the system will alert the predetermined appropriate facility staff member who can address the issue in a timely manner, thus protecting the valuable animals and/or equipment. The alerts can be in the form of e-mails, text messages to cell phones, voice calls, or any other type of electronic communication or visual or audio indication (e.g., alarm sounds or service lights illuminating).

For example, an embodiment of the system includes one or more devices. A primary device controls and monitors the main ventilated housing unit functions. A secondary device may be installed into one or more animal cages, such as those in the ventilated unit, to monitor and report in-cage environmental conditions. These devices are capable of causing one or more notification(s) to be sent to the user(s). These devices are preferably usable in connection with a network access point in some exemplary embodiments. Embodiments of the system may function wirelessly or be hard-wired to a facility network.

Other exemplary embodiments of the present invention preferably include one or more of the following: a primary component, such as an enhanced system controller device, a secondary component, such as an in-cage monitor, and/or a network access point.

For example, in one exemplary embodiment of the present invention, a primary component for monitoring the ventilated rack system is provided, wherein the primary component is arranged and configured to collect primary data, the primary data relating to one or more functions of the ventilated rack system and the primary component is arranged and configured to cause one or more alerts to be sent to one or more users based on at least a portion of the primary data and/or one or more predetermined primary parameters.

In another exemplary embodiment, the system includes a secondary component for analyzing and reporting environmental conditions proximate the secondary component, wherein the secondary component is arranged and configured to collect secondary data, the secondary data relating to one or more environmental conditions.

In another exemplary embodiment, both primary and secondary components are provided and the primary and secondary components are arranged and configured to electronically communicate with each other.

In another exemplary embodiment, a display is also included in the system. The display may be part of the primary component or the secondary component. The display may also be a separate device. The display may preferably be arranged and configured to receive either or both primary and secondary data and to display at least a portion of the primary and/or secondary data.

In another exemplary embodiment, the secondary component is arranged and configured to cause one or more alerts to be sent to one or more users based on at least a portion of the secondary data and/or one or more predetermined secondary parameters.

In another exemplary embodiment, the primary component is a system controller device. In certain embodiments, the system controller device includes a wired or wireless network communications device and electronic memory. The specific details and features of exemplary embodiments of a system controller device will be described below.

In another exemplary embodiment, the secondary component is an environmental monitoring device. In certain embodiments, the environmental monitoring device includes a wired or wireless network communications device and electronic memory. The specific details and features of exemplary embodiments of an environmental monitoring device will be described below.

In another exemplary embodiment, a network access point is also provided. The network access point is preferably arranged and configured to provide the one or more users with remote access to the primary data, the secondary data, or both the primary and secondary data. For instance, in one exemplary embodiment, the network access point may be arranged and configured to provide a web-accessible network interface, the web-accessible network interface configured to provide the one or more users with remote access to at least a portion of the primary data and/or the primary component, or the secondary data and/or the secondary component, or both the primary and secondary data and/or components, or any combination thereof.

In another exemplary embodiment, a network access point is arranged and configured to provide one or more users with access to the predetermined primary parameters. A user can preferably enter and/or modify the predetermined primary parameters. In another exemplary embodiment, the network access point is arranged and configured to provide one or more users with access to the predetermined secondary parameters. A user can also preferably enter and/or modify the predetermined secondary parameters.

In another exemplary embodiment, the primary component is arranged and configured to function as a stand-alone device. In another exemplary embodiment, the secondary component may preferably also be arranged and configured to function as a stand-alone device.

In another exemplary embodiment, the one or more users may retrieve primary data directly from the primary component. In another exemplary embodiment, the one or more users may retrieve secondary data directly from the secondary component. In another embodiment, either or both the primary data and secondary data may be stored at a remote location on a network, in part or in whole. A user can preferably access the primary and/or secondary data remotely through a computer or other types of mobile devices presently known or subsequently developed. A user may also preferably modify, change, or direct the location at which particular data is to be stored.

Other exemplary embodiments of the present invention include a monitoring and alert system for monitoring, analyzing, and/or reporting environmental conditions. The system may be used to monitor, analyze, and report environmental conditions in an animal cage or any other space, regardless of size or configuration. Exemplary embodiments include a secondary component, such as an environmental monitoring device. Other embodiments include a network access point. The specific details and features of exemplary embodiments of an environmental monitoring device and network access point will be described below.

One exemplary embodiment of a monitoring and alert system of the present invention includes a secondary component for analyzing and reporting environmental conditions proximate the secondary component, wherein the secondary component is arranged and configured to collect secondary data, the secondary data relating to one or more environmental conditions and the secondary component is arranged and configured to cause one or more alerts to be sent to one or more users based on at least a portion of the secondary data and one or more predetermined secondary parameters. The secondary component may preferably function as part of a system with other devices (where it may be configured and arranged to communicate with other devices) or it can function as a stand-alone device.

Another exemplary embodiment includes a display, either a separate device or integrated into the secondary component, the display arranged and configured to selectively display a portion of the data. Preferably, a user can select the data displayed.

In another exemplary embodiment, the secondary component includes at least one flange to facilitate suspension of the secondary component within or around an animal cage. In another exemplary embodiment, the secondary component includes a holding attachment for suspending, supporting, securing, or otherwise positioning the secondary component within or around an animal cage.

In another exemplary embodiment, the secondary component is an environmental monitoring device. In a preferred embodiment, the environmental monitoring device includes one or more walls and one or more perforations disposed on the one or more walls to permit air proximate the environmental monitoring device to enter the environmental monitoring device for analysis.

In another exemplary embodiment, the network access point is provided. The network access point is preferably arranged and configured to provide the one or more users with remote access to the secondary data, the predetermined secondary parameters, or both. Preferably, a user can enter and/or modify the secondary parameters. In another exemplary embodiment, the one or more users may retrieve secondary data directly from the secondary component. Preferably, a user can change or modify storage settings relating to the data and direct the location at which such data is to be stored. For example, data may be stored in the electronic memory provided on the secondary component or at a remote network location as discussed above. Preferably, a use can also direct a portion of data to be stored at a specific location. In other embodiments, a user can likewise change, modify, and direct the storage settings of primary data.

In another exemplary embodiment, a system controller device is provided wherein the system controller device preferably includes a wireless feature and a memory device, such as on-board flash memory. The system controller device is preferably configured and arranged to monitor the operation and/or functionality of a ventilated rack system, including without limitation, functions such as time since last pre-filter change, pre-filter status, fan run time, fan status, power level, filter status, air pressure, air temperature, connection status (e.g., robustness or integrity of electrical connections between parts/devices in rack system) (as further discussed below).

In another exemplary embodiment, the system controller device is preferably capable of monitoring one or more functions of a ventilated rack system. The system controller device preferably includes a control portion, wherein the control portion is arranged and configured to collect control data relating to the one or more functions of the ventilated rack system at a control sampling rate and the control portion is arranged and configured to cause one or more alerts to be sent to one or more users based on at least a portion of the control data and one or more predetermined control parameters. In other embodiments, the system controller device preferably includes a network communication device and a memory portion.

In another exemplary embodiment, the control portion is arranged and configured to control one or more functions of a ventilated rack system.

In another exemplary embodiment, the system controller device comprises an electronic display, the electronic display arranged and configured to selectively display control data.

In another exemplary embodiment, one or more predetermined control parameters can be entered and modified by one or more users.

In another exemplary embodiment, the control sampling rate can be entered and modified by the one or more users.

In another exemplary embodiment, at least a portion of the control data can be stored on a memory portion of the system controller device.

In another exemplary embodiment, the system controller device is arranged and configured to be connectable to an electronic network. In a preferred embodiment the control data is stored at a location on the network.

In another exemplary embodiment, the system controller device is arranged and configured to permit one or more users to remotely access at least a portion of the control data

In another exemplary embodiment, the system controller device is arranged and configured to electronically communicate with a network access point.

In another exemplary embodiment, the system controller device is arranged and configured to electronically communicate with an environmental monitoring device that detects and analyzes one or more environmental conditions (either within an animal cage or in any other environment).

In another exemplary embodiment, at least one of the one or more functions of the ventilated rack system includes time since last pre-filter change, pre-filter status, fan run time, fan status, power level, filter status, air pressure, air temperature, and connection status (e.g., robustness or integrity of electrical connections between parts/devices in rack system). One or more of these functions may be monitored and/or controlled using the system controller device. In other embodiments, the system controller device may also be used to monitor and/or control additional or other operations or functions relating to the system without limitation.

In another exemplary embodiment, the system controller device causes the one or more alerts to be sent to one or more mobile devices.

In another exemplary embodiment, the system controller device causes the one or more alerts to be sent to one or more electronic addresses. The electronic addresses may be associated with email, a computer network, a computer, laptop, tablet, mobile telephone, or any other mobile device presently known or subsequently developed.

In another exemplary embodiment, an in-cage monitor, which may function in conjunction with the primary component or as a stand-alone device, is preferably provided. The in-cage monitor may preferably be placed into one or more animal cages and can monitor and/or transmit data regarding the cage environment and conditions. In certain embodiments, the secondary component may, in conjunction with the primary component and/or a network access point, cause remote warnings of out of range operational parameters for a monitored cage or rack to be sent to a user. In another exemplary embodiment, the secondary component may, standing-alone (i.e. not in conjunction with a primary component or any other device), cause remote warnings of certain conditions and/or alerts to be sent to a user.

In another exemplary embodiment, an environmental monitoring device for detecting, analyzing and reporting one or more environmental conditions proximate the environmental monitoring device is provided. In an exemplary embodiment, the environmental monitoring device includes a monitor portion, wherein the monitor portion is arranged and configured to collect and analyze environmental data relating to the one or more environmental conditions at an environmental sampling rate, and the monitor portion is arranged and configured to cause one or more alerts to be sent to one or more users based on at least a portion of the environmental data and one or more predetermined environmental parameters. In another exemplary embodiment, the environmental monitoring device includes a network communication device and a memory portion (e.g., for selectively removable electronic memory).

In another exemplary embodiment, the environmental monitoring device is arranged and configured to cause one or more portions of environmental data to be displayed on a display.

In another exemplary embodiment, the memory portion of the environmental monitoring device is configured and arranged to store at least a portion of environmental data. In another exemplary embodiment, the environmental monitoring device is connectable to a network. In an exemplary embodiment, the environmental data may be stored at a location on the network. Regardless of storage location, in another exemplary embodiment, the environmental data is preferably remotely accessible by one or more users.

In another exemplary embodiment, the environmental monitoring device is arranged and configured to electronically communicate with a network access point.

In another exemplary embodiment, the environmental monitoring device is arranged and configured to electronically communicate with a system controller device that monitors one or more functions of a ventilated rack system (such as the embodiments discussed above).

In another exemplary embodiment, the environmental monitoring device includes one or more sensors for detecting one or more environmental conditions.

In another exemplary embodiment, at least one of the one or more environmental conditions monitored by the environmental monitoring device is time, temperature, humidity, light level, carbon dioxide level, or ammonia level. One or more of these parameters may be tracked using the environmental monitoring device. In other embodiments, the environmental monitoring device may also be adapted to monitor additional or other parameters without limitation and without deviating from the scope of the present invention.

In another exemplary embodiment, the environmental monitoring device includes one or more walls and one or more perforations constructed and arranged to permit air to flow into the environmental monitoring device, the one or more perforations disposed on the one or more walls.

In another exemplary embodiment, the environmental monitoring device includes at least one flange to facilitate suspension of the environmental monitoring device within an animal cage. In another exemplary embodiment, the environmental monitoring device includes a holding attachment for positioning the environmental monitoring device within an animal cage.

In another exemplary embodiment, the environmental monitoring device causes one or more alerts to be sent to one or more mobile devices. In another exemplary embodiment, the environmental monitoring device causes the one or more alerts to be sent to one or more electronic addresses. The electronic addresses may be associated with email, a computer network, a computer, laptop, tablet, mobile telephone, or any other mobile device presently known or subsequently developed.

A “black box” access point that interfaces with the other system components, e.g., the controller device, and cage monitor is also provided in exemplary embodiments of the present invention. For example, in one embodiment, the access point preferably provides a user with a web accessible interface that gives the user access to the data received and collected by the controller device and/or the environmental monitoring device. The access point also preferably is able to cause alerts of predetermined events to be electronically sent to a user.

In an exemplary embodiment of the present invention, a method of monitoring a ventilated animal housing system is provided. The method includes providing a system controller device adapted and configured to control and/or monitor the animal housing system, collecting control data relating to one or more functions of the ventilated animal housing system, analyzing at least a portion of the control data in reference to one or more predetermined control parameters, and causing one or more control alerts to be sent to one or more users in the event any portion of the control data triggers a control alert signal based on the one or more predetermined control parameters.

In another exemplary embodiment, one or more control alerts is a message sent to one or more mobile devices. In another exemplary embodiment, one or more control alerts are electronically sent to one or more electronic addresses. The electronic addresses may be associated with email, a computer network, a computer, laptop, tablet, mobile telephone, or any other mobile device presently known or subsequently developed. The one or more control alerts may be or include a visual alert and/or an audio alert.

In another exemplary embodiment, the method includes providing an environmental monitoring device adapted and configured to detect, analyze, and report one or more environmental conditions proximate the environmental monitoring device, collecting environmental data relating to the one or more environmental conditions, analyzing at least a portion of the environmental data in reference to one or more predetermined environmental parameters, and causing one or more environment alerts to be sent to the one or more users in the event any portion of the environmental data triggers an environment alert signal based on the one or more predetermined environmental parameters.

In another exemplary embodiment, the environmental monitoring device is arranged and configured to electronically communicate with a system controller device, such as the embodiments discussed above and herein.

In another exemplary embodiment, the method includes providing an electronic display and causing the at least a portion of the control data to be selectively displayed on the display. In another exemplary embodiment, at least a portion of environmental data may be selectively displayed on a display.

In another exemplary embodiment, the method includes providing a network access point, wherein the system controller device is arranged and configured to communicate with a network access point.

In another exemplary embodiment, the method includes providing a network access point, wherein the environmental monitoring device is arranged and configured to communicate with a network access point.

In another exemplary embodiment, a method of analyzing and reporting environmental conditions is provided. In one embodiment, the method includes providing an environmental monitoring device adapted and configured to detect, analyze, and report one or more environmental conditions proximate the environmental monitoring device, collecting environmental data relating to one or more environmental conditions, analyzing at least a portion of the environmental data in reference to one or more predetermined environmental parameters, and causing one or more environmental alerts to be sent to one or more users in the event any portion of the environmental data triggers an environmental alert signal based on the one or more predetermined environmental parameters.

In another exemplary embodiment, the method includes providing an electronic display and causing at least a portion of the environmental data to be selectively displayed on the display.

In another exemplary embodiment, the method includes providing a network access point, wherein the environmental monitoring device is arranged and configured to communicate with the network access point.

In another exemplary embodiment, the one or more environmental alerts is a message sent to one or more mobile devices. In another embodiment, the one or more environmental alerts is electronically sent to one or more electronic addresses. The electronic addresses may be associated with email, a computer network, a computer, laptop, tablet, mobile telephone, or any other mobile device presently known or subsequently developed. The one or more environmental alerts may be or include a visual alert and/or an audio alert.

While the present invention was developed primarily to protect research rodents housed in ventilated housing systems, it may be used on or with other types of animals, equipment, or entire facilities as well. For example, this system may also be used with biocontainment transport units and other like containers. The monitoring and alter system may also be adapted to monitor room conditions or be used in housing units for various laboratory animals, such as rodents or primates. The present invention may also be used to monitor Hydropac machines where preventive maintenance could be scheduled based off of remote monitoring of pouch counts or frequently reported warnings.

Additional features and advantages of embodiments of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE FIGURES

Embodiments of the invention will be described and shown in detail by way of example with reference to the accompanying drawings in which:

FIG. 1 is a network diagram of a monitoring and alert system in accordance with the present invention;

FIG. 2 is a front view of one embodiment of a system controller device installed in a ventilated housing unit in accordance with the present invention.

FIG. 3 is a perspective view of one embodiment of a system controller device installed in a ventilated housing unit in accordance with the present invention.

FIG. 4 is a top view of one embodiment of a system controller device installed in a ventilated housing unit in accordance with the present invention.

FIG. 5 is a side view of one embodiment of a system controller device installed in a ventilated housing unit in accordance with the present invention.

FIG. 6 is a front view of one embodiment of a system controller device in accordance with the present invention.

FIG. 7 is a rear view of one embodiment of a system controller device in accordance with the present invention.

FIG. 8 is a top view of one embodiment of a system controller device in accordance with the present invention.

FIG. 9 is a side view of one embodiment of a system controller device in accordance with the present invention.

FIG. 10 is a perspective front view of one embodiment of a system controller device in accordance with the present invention.

FIG. 11 is a perspective rear view of one embodiment of a system controller device in accordance with the present invention.

FIG. 12 is a top perspective view of one embodiment of a environmental monitoring device positioned in an animal cage in accordance with the present invention.

FIG. 13 is a top perspective view of one embodiment of an environmental monitoring device in accordance with the present invention.

FIG. 14 is a bottom perspective view of one embodiment of an environmental monitoring device in accordance with the present invention.

FIG. 15 is a side view of one embodiment of an environmental monitoring device in accordance with the present invention.

FIG. 16 is a top view of one embodiment of an environmental monitoring device in accordance with the present invention.

FIG. 17 is a perspective view of one embodiment of an environmental monitoring device with lid open in accordance with the present invention.

FIG. 18 is a top perspective view of one embodiment of an environmental monitoring device without a lid in accordance with the present invention.

FIG. 19 is a top perspective view of one embodiment of an environmental monitoring device with lid closed in accordance with the present invention.

FIG. 20 is a side view of one embodiment of an environmental monitoring device with lid closed in accordance with the present invention.

FIG. 21 is a side cross-sectional view of one embodiment of an environmental monitoring device with lid closed in accordance with the present invention.

FIG. 22 is a side cross-sectional view of one embodiment of an environmental monitoring device with lid closed in accordance with the present invention.

FIG. 23 is a top perspective view of an electronic PC board for an environmental monitoring device in accordance with the present invention.

FIG. 24 is a bottom perspective view of an electronic PC board for an environmental monitoring device in accordance with the present invention.

FIG. 25 is an illustration of one embodiment of a network access point in accordance with the present invention.

FIG. 26 is a flow diagram illustrating the steps of a preferred embodiment of the present invention.

FIG. 27 is a flow diagram illustrating the steps of a preferred embodiment of the present invention.

FIG. 28 is a flow diagram illustrating the steps of a preferred embodiment of the present invention.

FIG. 29 is a flow diagram illustrating the steps of a preferred embodiment of the present invention.

FIG. 30 is an internal rear view of a system controller device in accordance with the present invention.

### DETAILED DESCRIPTION OF EXEMPLARY EMBODIMENTS

An exemplary embodiment of the present invention includes a primary component 100 and a network access point 300. The primary component 100 and network access point 300 may include firmware, software and other programs. As further described below, the primary component may be used as a stand-alone device or as part of monitoring and alert systems. Such systems are preferably capable of providing a fully wireless monitoring and alert system, but may also optionally be hard-wired within a facility.

Other exemplary embodiments of the present invention include a secondary component 200, which may include firmware, software, and other programs. As further described below, the secondary component 200 may be used as a stand-alone device or as part of monitoring and alert systems.

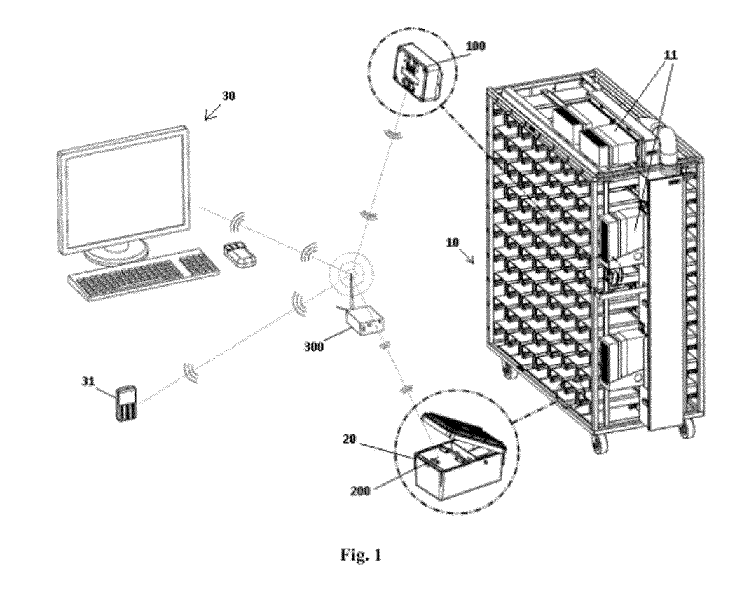

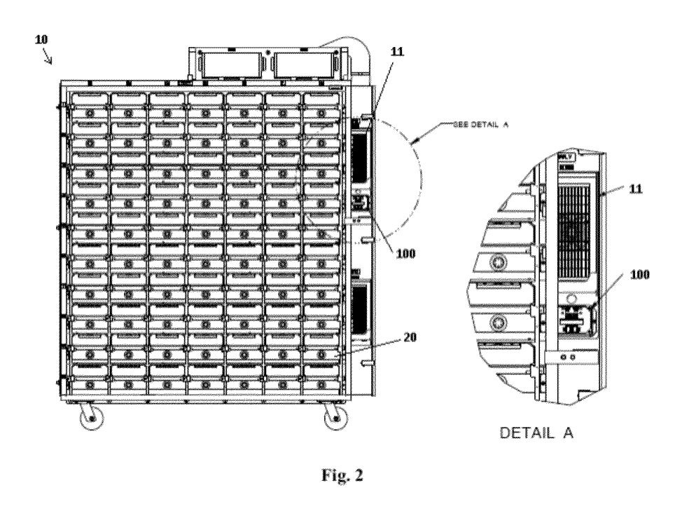

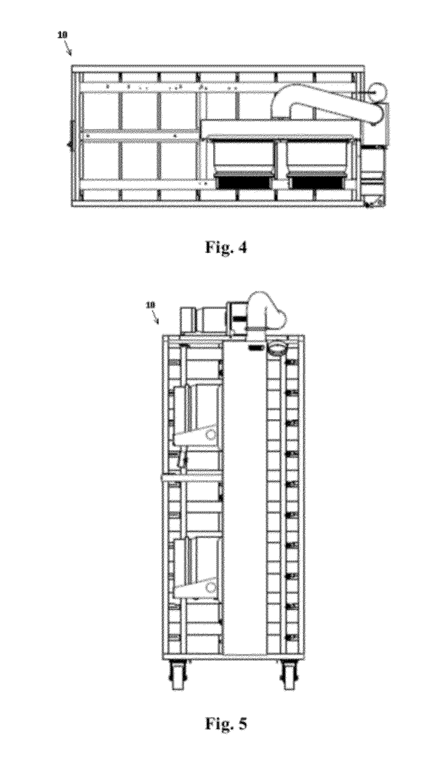

With reference to FIGS. 1-5, an embodiment of a primary component 100 is capable of controlling and monitoring one or more ventilated housing units 10 for proper operation and function. The primary component 100 may also collect and store data relating to one or more functions of the ventilated housing unit 10. In other preferred embodiments, the primary component 100 may be used in conjunction with the secondary component 200, with a network access point 300 in another embodiment, with other suitable devices in another embodiment (see, e.g., FIG. 1), or as a stand-alone device in another embodiment (see, e.g., FIG. 2). The primary component 100 may optionally be provided (as a stand-alone device or in conjunction with a secondary component 200 or a network access point 300) with new ventilated housing units 10, or can replace existing control devices (not shown). For example, basic controller devices are currently available from Lab Products, Inc., such as the RAIR™ system controller (ventilated rack/equipment air system control device). The primary component 100 is also preferably backwards compatible with existing RAIR™ systems sold and offered for sale by Lab Products, Inc. and/or other ventilated rack systems that are on the market.

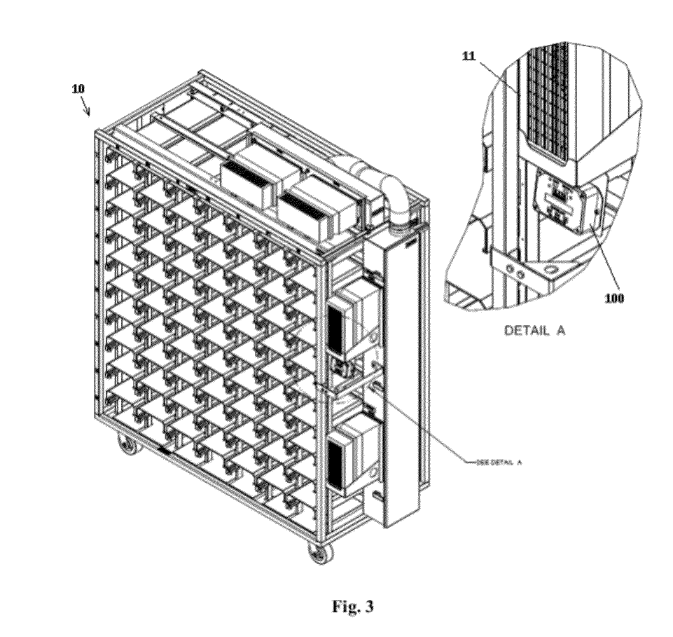

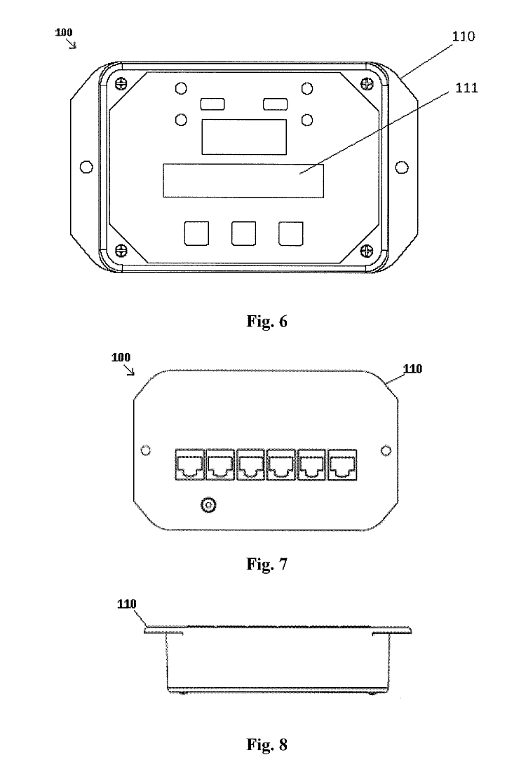

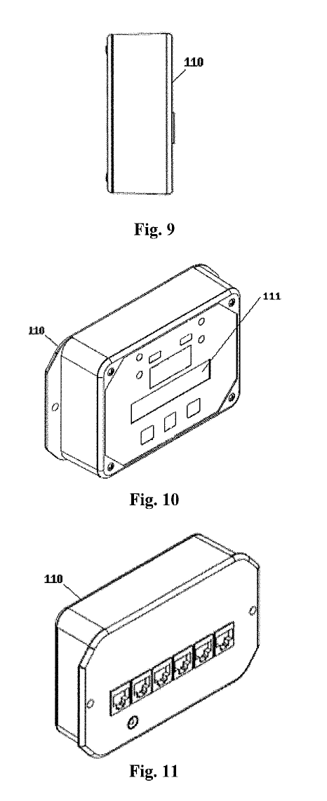

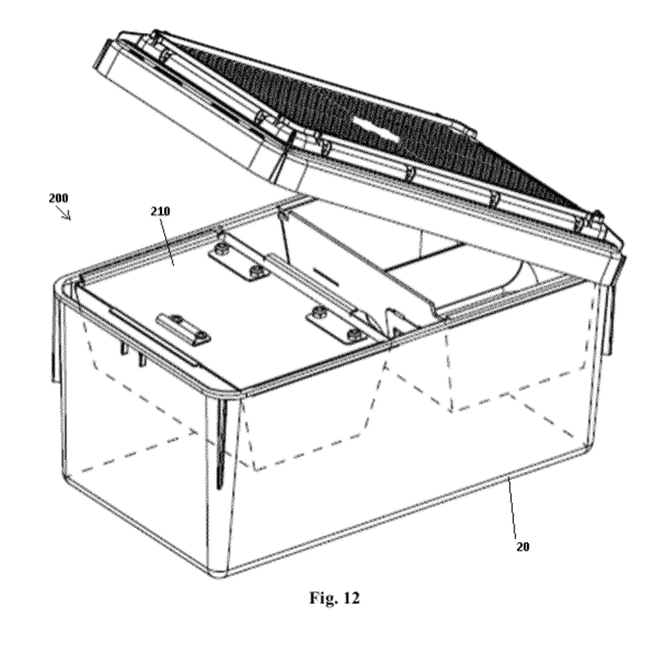

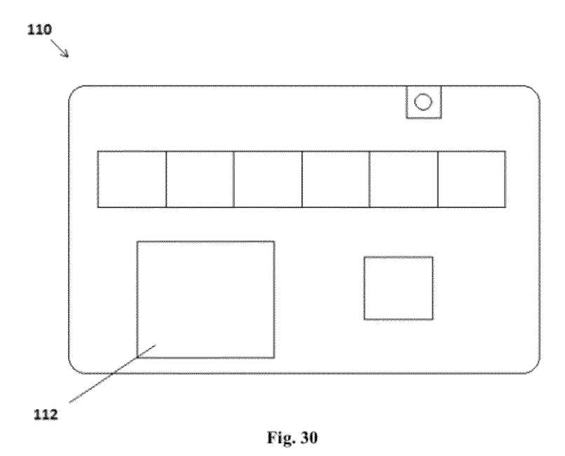

With reference to FIGS. 2-11, 26, 28, and 30, in an exemplary embodiment of the present invention, the primary component 100 includes an enhanced system controller device 110 with wireless capability 112, for example and without limitation a bluetooth device, a LAN card, a mobile wireless card, broadband card, or any other wireless feature presently known or later developed (e.g., the RF100PC6 wireless transceiver made by Synapse Wireless, Inc. or other similar devices), and expanded memory, such as on-board flash memory or any other type of electronic memory presently known or later developed. The enhanced controller device 110 is preferably capable of controlling various functional and operational aspects of a ventilated unit 10 (see FIGS. 2-3) (e.g., relating to the fans and/or air delivery system). Specifically, the enhanced controller device 110 may preferably be used to keep track of one of more of the following parameters without limitation: airflow measurements, air temperature passing through the air unit, electrical consumption, power loss, weight of equipment, the number of days since last pre-filter change, air pressure at certain positions of the ventilated unit (e.g., the housing unit plenum, measured at the mounting juncture between the air unit and plenum), fan lifetime run hours, pressure differential across one or more HEPA filters, fan performance (e.g., provided as a percentage of maximum RPM's), and monitoring whether all required air units are connected.

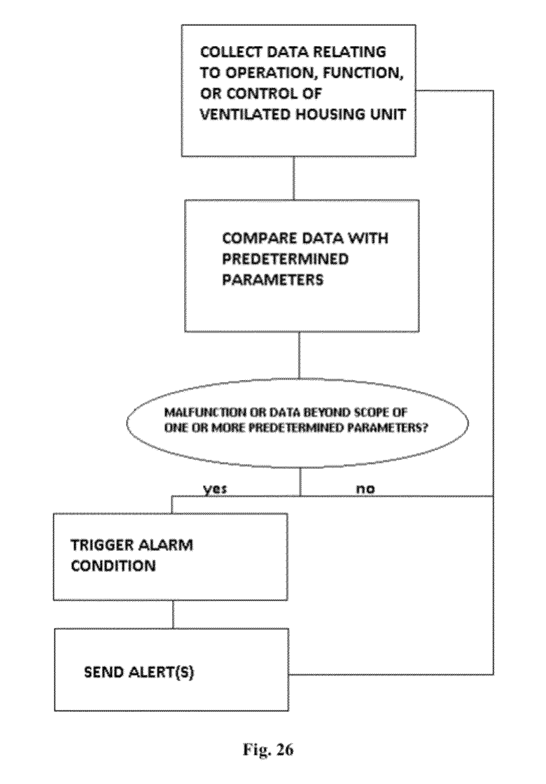

Referring to FIG. 26, the enhanced controller device 110 triggers an alarm condition if one of the controlled systems is not functioning properly or falls beyond, above, or below an acceptable operational range, point, or parameter (e.g., loss of power, any fan units not online, a fan failure, HEPA filter requires changing and is at critical stage, air system pressure is out of range, etc.). In exemplary embodiments, the enhanced controller device 110 preferably causes alerts to be sent to selected users in the event of such alarm condition. As discussed further below, and with reference to FIG. 1, the alerts may be in the form of an electronic message sent via email or to an electronic address received via a computer 30, laptop, mobile device 31, or any other user device.

In other embodiments, the enhanced controller device 110 also preferably causes service alerts to be sent to selected users (which may be the same or different users receiving the alerts in the event of an alarm condition), indicating when normal service is required (e.g., pre-filter changes and HEPA filter replacements due). Specifically, in exemplary embodiments, the enhanced controller device 110 may preferably be used to keep track any or all of the following service requirements: pre-filter cleaning and/or replacement due, report dirty HEPA filters, air pressure out of range (e.g., when a clean-out door is open and/or where an air unit is not docked properly on the housing unit), report system running self diagnostics, fan failure (e.g., fan not spinning), or whether any device (e.g., air unit) or connection is required but not properly plugged in. In exemplary embodiments, the enhanced controller device 110 preferably causes remote (on-site or off-site or both) reporting of any or all of these service conditions as well as any or all operational alerts (e.g., power failures and unit shut downs as discussed above).

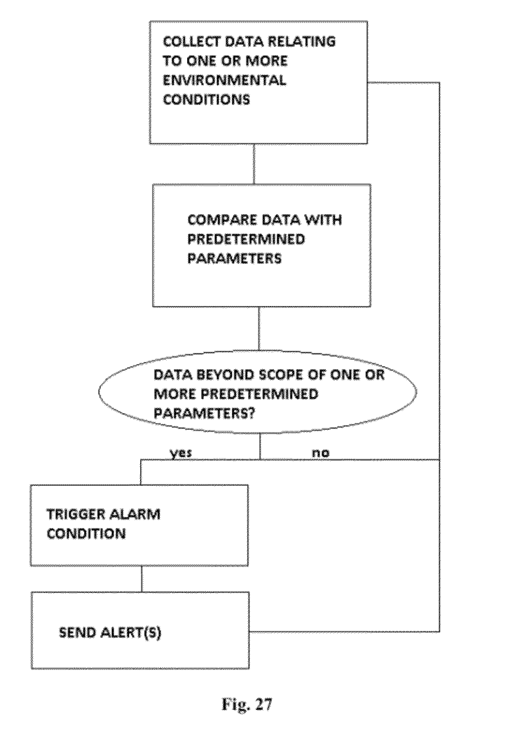

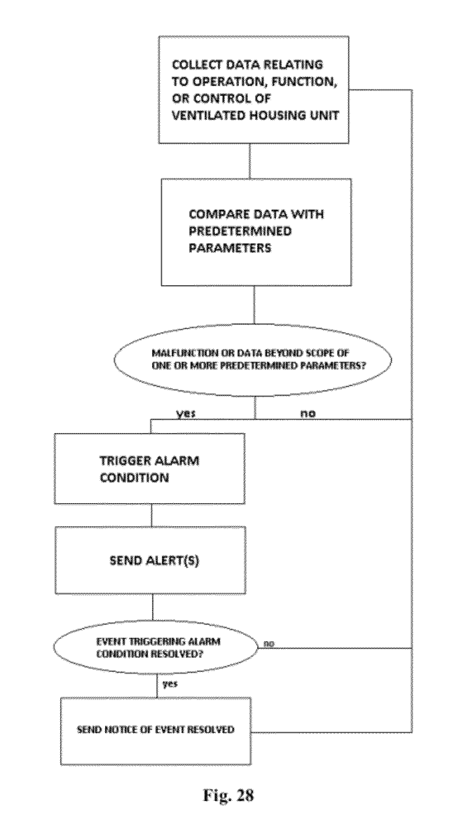

In an exemplary embodiments, for example, as shown in FIG. 1, the alerts and service warnings may preferably be in the form of a text message, instant messaging, or e-mail communicating the fault or condition that triggered the message and may preferably include the animal holding room/cage number and rack identification number (see also, e.g., FIGS. 26-27). A user may receive another electronic communication when the fault or triggering condition has been resolved (see e.g., FIG. 28). In other embodiments, similar alerts and notifications may be sent to users via other electronic means (e.g., cellular text message or a message to other mobile devices 31 or other electronic addresses). In other embodiments, the alert may be visual or audio alerts (e.g., lights or sounds). Such visual/audio alters may be supplied in addition to or as an alternative to electronic message alerts. The above-discussed alerts may be sent to users where the primary component 100 is used in stand-alone applications and in conjunction with other devices and/or systems (e.g., without limitation, a secondary component 200, network access point 300, etc.).

The triggering conditions and/or service or other alerts may be modified or turned on or off by the user, e.g., with the use of a pass code in system program settings. A user may preferably modify and/or turn on/off such alerts by directly or remotely accessing the system controller device 110 or the ventilated housing unit 10. In preferred embodiments, a user may perform these functions, in part or in whole, via the web accessible network interface provided on the network access point 300 (discussed below).

The enhanced controller device 110 preferably includes a display 111, such as an LCD display. When used in conjunction with a secondary component 200, the enhanced controller device 110 preferably accepts signals and/or data from the secondary component 200 and allows information and/or data from the secondary component 200 to be displayed on the display 111.

The enhanced controller device 110 may preferably be configured and arranged to run self-diagnostics routines in relation to the monitored ventilated housing unit 10. Such self-diagnostics routines may, without limitation, ensure that all sensors relating to the monitored ventilated housing unit 10 or system are operation and/or regulate airflow to set-points. A user may preferably set the specifications for such self-diagnostic routines. Self diagnostic routines may preferably be automated. In embodiments where the system controller device 110 is used in conjunction with a network access point 300, the web accessible interface provided on the network access point 300 (discussed below) may be used in connection with setting up, maintaining, and/or overseeing such self-diagnostic routines.

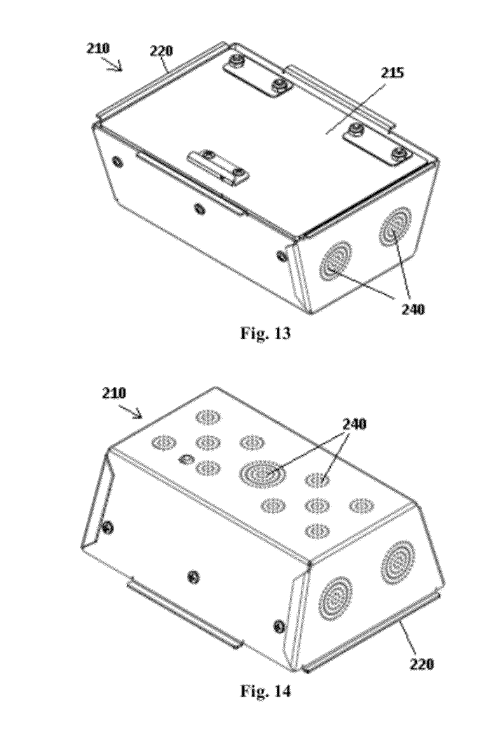

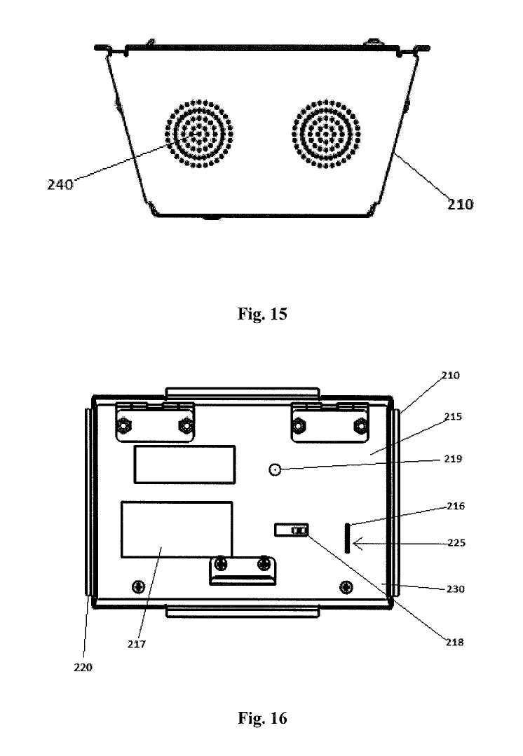

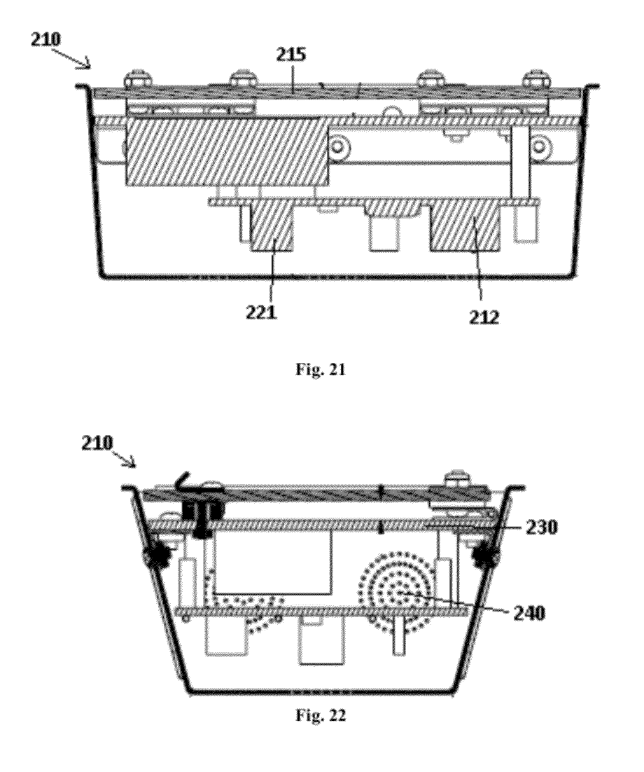

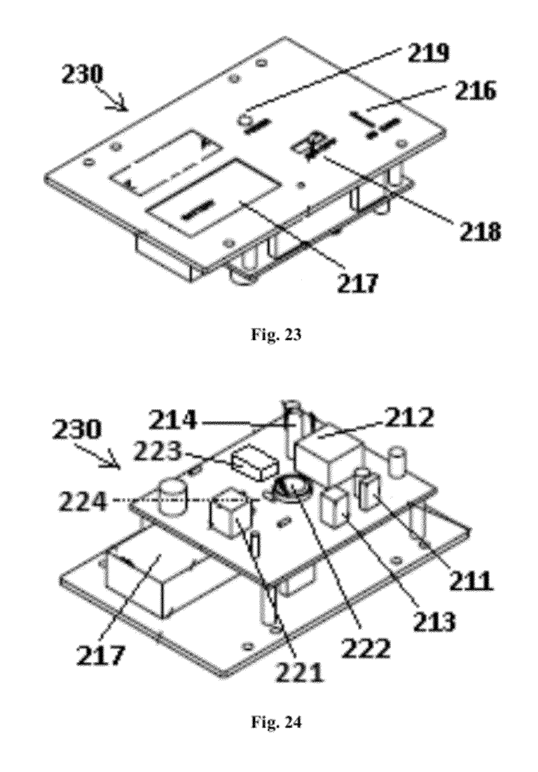

FIGS. 12-24 depicts embodiments of a secondary component 200, which is preferably capable of monitoring and reporting cage 20 environmental conditions. In preferred embodiments, the secondary component may cause alerts to be sent to selected users when certain environmental conditions occur. Embodiments of a secondary component 200 may also be used to monitor environmental conditions in larger areas (e.g., rooms, other laboratory spaces), without limitation. The secondary component 200 may be used in conjunction with the primary component 100 in one embodiment of the present invention, in conjunction with a network access point 300 in another embodiment, or with other suitable devices in another embodiment, or as a stand-alone environmental monitoring device in another embodiment.

In an exemplary embodiment, the secondary component 200 includes an environmental monitoring device 210 that may be placed into one or more animal cages 20 or rooms for cage/room-level condition monitoring and/or data logging. The environmental monitoring device 210 preferably detects, collects, monitors, reports and/or logs data relating to environmental conditions, for example, certain desired parameters of the in-cage environment, which may include readings for, but is not limited to: time, temperature, humidity, light level, sound levels (both in and outside of cages), carbon dioxide (CO2), ammonia (NH3), and other microenvironment conditions. The environmental monitoring device 210 may also be adapted to monitor other or additional environmental conditions without deviating from the scope of the present invention.

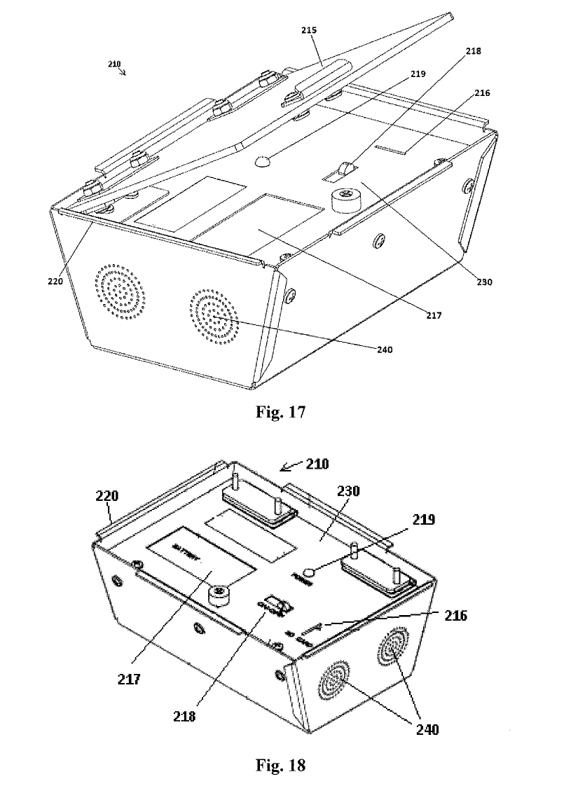

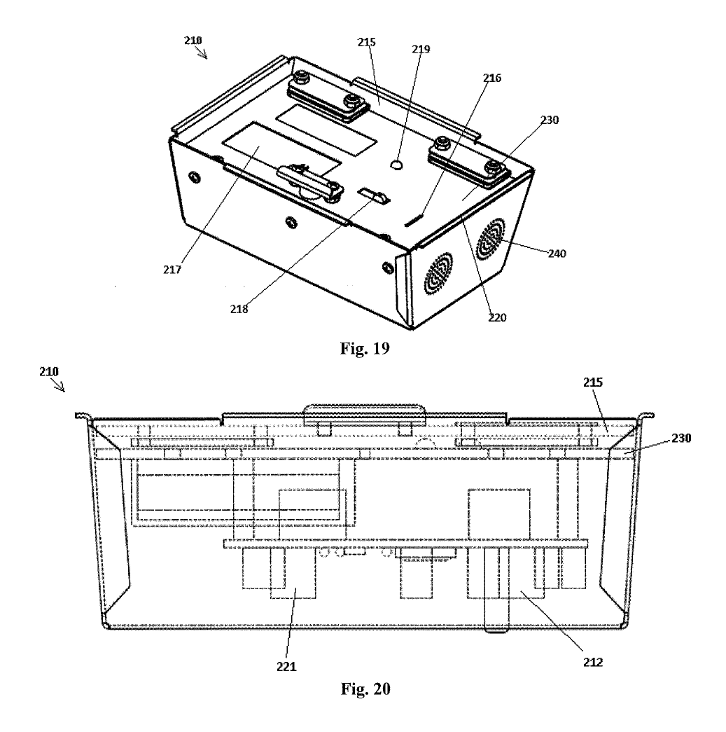

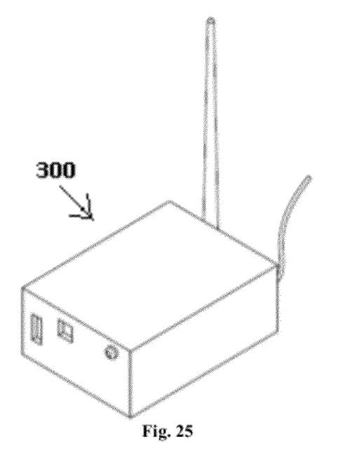

The environmental monitoring device 210 is a preferably a single, self-contained, wireless device that may reside entirely within a sealed, populated animal cage 20 (see FIG. 12). The environmental monitoring device 210 is preferably protected from animal claw and chew damage. For example, the housing of the environmental monitoring device 210 may be made of stainless steel and the top cover 215 made of clear plastic (see FIGS. 17 and 19). The cover 215 preferably protects components such as an indicator light source 219 (for example, a LED powered light), an on/off switch 218, a battery compartment 217, and an interface for electronic memory, such as memory chip slot 216, and electronic memory 225 to store/log data relating to the cage conditions and environmental conditions. The electronic memory 225 may be an SD memory card or any other type of electronic memory presently known or later developed. The environmental monitoring device 210 preferably also includes sensors, such as humidity sensor 211, ammonia sensor 212, temperature sensor 213, carbon dioxide sensor 221, and light sensor 214 (see FIG. 24). These components may preferably be supported by a PC board 230. In other preferred embodiments, the environmental monitoring device 210, includes a wireless capability 223, for example and without limitation a bluetooth device, a LAN card, a mobile wireless card, broadband card, or any other wireless feature presently known or later developed (e.g., the RF100PC6 wireless transceiver made by Synapse Wireless, Inc. or other similar devices). The environmental monitoring device 210 also preferably includes one or more perforations 240 that permit air from the surrounding environment to enter the environmental monitoring device 210 for analysis.

In an exemplary embodiment, the secondary component 200 is preferably constructed and arranged to be used with cages 20 of different sizes cages and/or various other cage accessories and/or cage or ventilation rack features and functions. For example, in one exemplary embodiment, the environmental monitoring device 210 is preferably placed inside a cage 20 such that it is positioned above and a distance away from the cage floor to allow for proper air circulation through the device. For example, the environmental monitoring device 210 may be positioned in this manner using a flange 220. The environmental monitoring device 210 may be supported via the flange 220 by one or more side walls of the cage 20, using a lip or recess provided on the cage 20 or any other suitable part of the cage 20 (see FIG. 12). This type of support may be preferable when the environmental monitoring device 210 is used in smaller cages 20. In another exemplary embodiment, a holding attachment, which may include any type of fastening apparatus or component, without limitation, may be provided (not shown), wherein the holding attachment is capable of supporting the environmental monitoring device 210 in the cage. This type of support may be preferable when the environmental monitoring device 210 is used in larger cages or in cages with wire bar lids (not shown).

Multiple environmental monitoring devices 210 may be used in the same ventilated housing unit 10 and/or in the same cage 20. The environmental monitoring device 210 monitors the cage environment and collects, reports and/or stores data relating to cage environmental conditions, such as those described above.

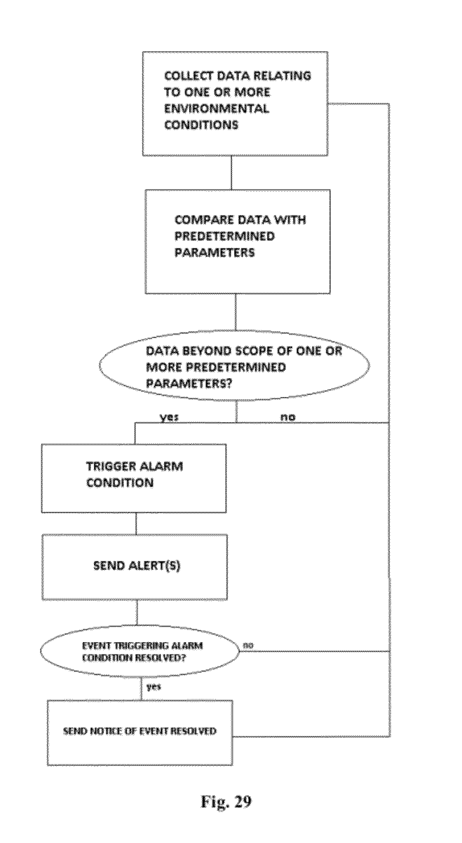

With reference to FIGS. 27 and 29, the environmental monitoring device 210 is preferably capable of causing an alert to be sent to specified users in the event any of the in-cage environmental conditions falls outside, over, or under a specified parameter, point, or range. The alert may be an email, text message, a visual signal, audio signal, or any other type of alert electronically or remotely sent to a user. The user(s) receiving the alert caused by the environmental monitoring device 210 may be the same or different as those associated with alerts caused by the primary component 100. For example, without limitation, a selected user will receive the alert message in the form of a text message or e-mail communicating the fault or condition that triggered the message as well as the animal holding room/cage number and rack identification number. In another embodiment, the user may receive another electronic communication when the fault or triggering condition has been resolved. Alerts and notifications may be sent to users where the secondary component 200 is used in stand-alone applications and in conjunction with other devices and/or systems (e.g., without limitation, a primary component 100, a network access point 300, etc.).

In an exemplary embodiment, the data collected by the environmental monitoring device 210 may be stored as a CSV (coma separated value file) or XML file which can be loaded into commercially available software such as Microsoft Excel or similar programs for data organization. Furthermore, the data sampling rate of the environmental monitoring device 210 is preferably settable and modifiable by a user. For example, a user may change the sampling rate by altering the intervals of the time-clock managed wake-on-demand function. In one exemplary embodiment, where the secondary component 200 is used in conjunction with a network access point 300, the settings may be changed by a user via a website (for example, and without limitation, the web accessible network interface discussed below). In another embodiment, where the secondary component 200 is used as a stand-alone device, the user may access a file or program residing on the device's electronic memory 225 (either directly or remotely) to enter or edit desired data sampling settings. Thus, the user may set sampling rates to particular intervals or times, as desired.

The environmental monitoring device 210 is preferably powered by a wireless power source, such as disposable or rechargeable batteries 217. In one embodiment, the environmental monitoring device 210 may be woken up on demand by a time-clock managed wake-on-demand function, which helps to preserve and extend battery life. A PC board mounted time clock 224 (see FIG. 24) is preferably provided to wake the system up for sampling/data gathering. Such PC board mounted time clock 224 is preferably powered by a secondary battery 222, such as a PC board mounted button type battery (see FIG. 24). Based on user settings or input, the time clock 224 is capable of causing the environmental monitoring device 210 to be “woken-up” to perform its functions (e.g., monitor, log, and take readings for the above-mentioned parameters) at specified intervals. Battery life is significantly extended as all unit functionality except the time clock 224 is powered off unless sampling is being preformed.

The data collected by the primary component 100 and/or secondary component 200 may preferably be made available for importing into total facility monitoring systems. Environmental data may be stored, in whole or in part, at any location selected by a user. For example, data may be stored on the electronic memory 225 of the environmental monitoring device 210. In exemplary embodiments, a user may remotely access and download the data stored on the environmental monitoring device 210 via the environmental monitoring device's 210 wireless capability 223. A user may also directly access the data by removing the electronic memory 225 and accessing the memory 225 via a computer. In other embodiments, the environmental monitoring device 210 is connectable to an electronic network and the data collected by the environmental monitoring device 210 may be stored at a location on the network. For example, when used in conjunction with a network access point 300, such as the system depicted in FIG. 1, the data collected and stored by the environmental monitoring device 210 may be accessed via a web-accessible interface (further described below) provided by the network access point 300.

In other embodiments, when used in conjunction with a primary device, such as the system depicted in FIG. 1, the environmental monitoring device 210 is preferably capable of communicating wirelessly with the primary component 100 and/or an access point 300. Data collected by the environmental monitoring device 210 may be displayed on the display 111 of the enhanced system controller device 110, as discussed above.

With reference to FIGS. 1 and 25, an exemplary embodiment, a network access point 300, such as a commercially available “black box” network access point, is provided. The network access point 300 is preferably capable of wirelessly interfacing with the primary component 100 and/or secondary component 200. The network access point 300 is preferably capable of causing the above-discussed control, service, and environmental alerts and notifications to be sent to selected users, for example and without limitation, via e-mail, text message, instant message, or any other remote and/or electronic means presently know or later developed. The network access point 300 may be used to export the alerts and data received by the primary component 100 and/or secondary component 200. The network access point 300 also preferably provides web access to the conditions and functions monitored by the primary component 100 and/or secondary components 200 (including data received, collected, and/or stored on such devices). The web interface is preferably user maintainable and customizable (either fully or in part).

The network access point 300 preferably hosts a web accessible network interface optionally connectable with a laboratory's internal networks and systems where the functions and operation of the ventilated housing unit(s) 10, including data collected and received by the primary component 100 may be monitored. The web accessible network interface also preferably provides access to the environmental conditions of the animal cages/ventilated housing unit(s), including data collected by the secondary component 200. Data collected and/or received by the primary and secondary components may further be stored on memory provided on the network access point 300 at a user's option and direction. A user can also preferably access and/or control the primary and/or secondary components via the network interface and modify certain settings of such components (e.g., the sampling rate as discussed above). From this web accessible network interface, a user can thus remotely access check the status of each piece of equipment or check the cage environmental conditions. Accordingly, the user will be able to ascertain if any set up piece of equipment is online or offline from this network interface.

For added security and/or organization, the web accessible interface may be password protected. From this password protected web accessible interface appropriate users will be allowed to add user data such as contact information, e.g., e-mail addresses or cell phone numbers for text message distribution and subscribe to any or all control, service, and/or environmental alerts. The user will also have the ability to give each piece of monitored equipment a unique identifier, such as a number, which in many cases may consist of a rack number and a room number. A laboratory may also choose to assign identifying information for certain pieces or parts of equipment monitored. Such information may also be stored and preset via the network interface.

The network access point 300 may preferably be equipped with wireless internet access, such as a user supplied cellular internet access card, for a fully wireless system to simplify the installation and/or set up. Signal repeaters may be provided as required on installations requiring longer range signals.

One network access point 300 is preferably capable of handling multiple ventilated housing, or similar units. However, any number of network access points 300 may be used in conjunction with any number of ventilated rack systems 10, cages 20, primary components 100, or secondary components 200 without deviating from the scope of the present invention.

The network access point 300 is further preferably capable of storing and/or accessing all desired user data, including contact information, such as cell phone numbers or e-mail addresses, as well as all other desired data (e.g., any other electronic addresses, parameters, etc.). Thus, the monitoring and alert system does not require a computer (i.e., a PC) to send e-mails and text messages in one exemplary embodiment. However, any of the above components, may be used in conjunction with one or more computers 30 (i.e., PC's) in another exemplary embodiment.

In an exemplary embodiment, the primary component 100, such as the controller device 110, communicates with the network access point 300. In another exemplary embodiment, the secondary component 200, such as the environmental monitoring device 210, is capable of communicating with the network access point 300 via a wireless signal. The network access point 300 preferably includes wireless features but could be hard wired to facility network if such a connection is required for security or other desired purposes.

In an exemplary embodiment, the network access point 300 may preferably also be equipped with a backup power source, for example, a battery. This preferably allows the network access point 300 to provide users with facility-related alerts and/or notifications. Often, a laboratory or research facility may have a facility-wide monitoring system (e.g., that would monitor the power, lighting, HVAC, etc. in the building(s)). In one embodiment, the network access point 300 may be capable of electronically communicating with such facility monitoring systems. Based on predetermined settings, the network access point 300 may, thus, send one or more users an electronic communication alerting such users of a facility's status. In another exemplary embodiment, the network access point 300 may also preferably, based on data from the primary and/or secondary components 100, 200, notify users in the event of multiple concurrent failures or alerts (either in related or unrelated components, e.g., a section of cages 20 or a row of ventilated racks 10). Thus, the network access point 300 may also act as a facility warning device in certain embodiments.

Any number of above-described components may preferably be used alone or in conjunction with each other in any configuration to achieve the desired monitoring system. The versatility of these components allow for ease of system expansion and upgrades.

The above-described components of the present invention may preferably also be added to or adapted to existing laboratory equipment and/or facilities, including but not limited to cages 20, ventilated rack systems 10, rooms, air systems, filtration systems, etc.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there had been shown and described fundamental features of the invention as applied to exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A monitoring and alert system for use with a ventilated rack system, the system comprising:
a primary component for monitoring the ventilated rack system, wherein
the primary component is arranged and configured to collect primary data, the primary data relating to one or more functions of the ventilated rack system;
the primary component is arranged and configured to cause one or more alerts to be sent to one or more users based on at least a portion of the collected primary data and one or more predetermined primary parameters.

2. The system of claim 1 further comprising a secondary component for analyzing and reporting environmental conditions proximate the secondary component, wherein the secondary component is arranged and configured to collect secondary data, the secondary data relating to one or more environmental conditions.

3. The system of claim 2 wherein the secondary component is arranged and configured to electronically communicate with the primary component.

4. The system of claim 3 wherein the primary component further includes a display.

5. The system of claim 4 wherein the primary component is arranged and configured to receive secondary data and to display at least a portion of the secondary data on the display.

6. The system of claim 2 wherein:
the secondary component is arranged and configured to cause one or more alerts to be sent to one or more users based on at least a portion of the collected secondary data and one or more predetermined secondary parameters.

7. The system of claim 1 wherein the primary component is a system controller device.

8. The system of claim 2 wherein the secondary component is an environmental monitoring device.

9. The system of claim 1 further comprising a network access point arranged and configured to provide the one or more users with remote access to the primary data.

10. The system of claim 1 further comprising a network access point arranged and configured to provide a web-accessible network interface, the web-accessible network interface configured to provide the one or more users with remote access to at least a portion of the primary data and the primary component.

11. The system of claim 2 further comprising a network access point arranged and configured to provide the one or more users with remote access to the secondary data.

12. The system of claim 2 further comprising a network access point arranged and configured to provide a web-accessible network interface, the web-accessible network interface configured to provide the one or more users with remote access to at least a portion of the secondary data and the secondary component.

13. The system of claim 1 further comprising a network access point arranged and configured to provide the one or more users with access to the predetermined primary parameters.

14. The system of claim 2 further comprising a network access point arranged and configured to provide the one or more users with access to the predetermined secondary parameters.

15. The system of claim 1 wherein the primary component is arranged and configured to function as a stand-alone device.

16. The system of claim 2 wherein the secondary component is arranged and configured to function as a stand-alone device.

17. The system of claim 1 wherein the one or more users may retrieve primary data directly from the primary component.

18. The system of claim 2 wherein the one or more users may retrieve secondary data directly from the secondary component.

19. A monitoring and alert system for monitoring and reporting environmental conditions, the system comprising:
a secondary component for analyzing and reporting environmental conditions proximate the secondary component, wherein
the secondary component is arranged and configured to collect secondary data, the secondary data relating to one or more environmental conditions;
the secondary component is arranged and configured to cause one or more alerts to be sent to one or more users based on at least a portion of the collected secondary data and one or more predetermined secondary parameters.

20. The system of claim 19 further comprising a display device arranged and configured to selectively display secondary data.

21. The system of claim 19 wherein the secondary component further includes at least one flange to facilitate suspension of the secondary component within an animal cage.

22. The system of claim 19 wherein the secondary component further includes a holding attachment for positioning the secondary component within an animal cage.

23. The system of claim 19 wherein the secondary component is an environmental monitoring device.

24. The system of claim 23 wherein the environmental monitoring device further includes:
one or more walls; and
one or more perforations disposed on the one or more walls to permit air proximate the environmental monitoring device to enter the environmental monitoring device for analysis.

25. The system of claim 19 further comprising a network access point arranged and configured to provide the one or more users with remote access to the secondary data.

26. The system of claim 19 further comprising a network access point arranged and configured to provide the one or more users with access to the predetermined secondary parameters.

27. The system of claim 19 wherein the secondary component is arranged and configured to function as a stand-alone device.

28. The system of claim 19 wherein the one or more users may retrieve secondary data directly from the secondary component.

29. A system controller device for monitoring one or more functions of a ventilated rack system, the system controller device comprising:
a control portion, wherein
the control portion is arranged and configured to collect control data relating to the one or more functions of the ventilated rack system at a control sampling rate; and
the control portion is arranged and configured to cause one or more alerts to be sent to one or more users based on at least a portion of the collected control data and one or more predetermined control parameters.

30. The system controller device of claim 29 wherein the control portion is arranged and configured to control the one or more functions of a ventilated rack system.

31. The system controller device of claim 29 further comprising an electronic display, the electronic display arranged and configured to selectively display control data.

32. The system controller device of claim 29 wherein the control portion is arranged and configured such that the one or more predetermined control parameters can be entered and modified by the one or more users.

33. The system controller device of claim 29 wherein the control portion is arranged and configured such that the control sampling rate can be entered and modified by the one or more users.

34. The system controller device of claim 29 further comprising a memory portion for storing at least a portion of the control data.

35. The system controller device of claim 29 wherein the system controller device is arranged and configured to be connectable to an electronic network.

36. The system controller device of claim 29 wherein the system controller device is arranged and configured to permit the one or more users to remotely access at least a portion of the control data.

37. The system controller device of claim 29 wherein the system controller device is arranged and configured to electronically communicate with a network access point.

38. The system controller device of claim 29 wherein the system controller device is arranged and configured to electronically communicate with an environmental monitoring device that analyzes one or more environmental conditions.

39. The system controller device of claim 29 wherein at least one of the one or more functions of the ventilated rack system is selected from the group consisting of pre-filter time, pre-filter status, fan run time, fan status, power level, filter status, air pressure, air temperature, connection status.

40. The system controller device of claim 29 wherein the system controller device causes the one or more alerts to be sent to one or more mobile devices.

41. The system controller device of claim 29 wherein the system controller device causes the one or more alerts to be sent to one or more electronic addresses.

42. An environmental monitoring device for detecting, analyzing and reporting one or more environmental conditions proximate the environmental monitoring device, the environmental monitoring device comprising:
a monitor portion, wherein:
the monitor portion is arranged and configured to collect and analyze environmental data relating to the one or more environmental conditions at an environmental sampling rate; and
the monitor portion is arranged and configured to cause one or more alerts to be sent to one or more users based on at least a portion of the collected environmental data and one or more predetermined environmental parameters.

43. The environmental monitoring device of claim 42, wherein the environmental monitoring device is arranged and configured to cause one or more portions of environmental data to be displayed on a display.

44. The environmental monitoring device of claim 42 further comprising a memory portion for storing at least a portion of the environmental data.

45. The environmental monitoring device of claim 42, wherein the environmental monitoring device is arranged and configured to be connectable to an electronic network.

46. The environmental monitoring device of claim 42, wherein the environmental monitoring device is arranged and configured to permit the one or more users to remotely access at least a portion of the environmental data.

47. The environmental monitoring device of claim 42 wherein the environmental monitoring device is arranged and configured to electronically communicate with a network access point.

48. The environmental monitoring device of claim 42 wherein the environmental monitoring device is arranged and configured to electronically communicate with a system controller device that monitors one or more functions of a ventilated rack system.

49. The environmental monitoring device of claim 42 further including one or more sensors for detecting the one or more environmental conditions.

50. The environmental monitoring device of claim 42, wherein at least one of the one or more environmental conditions is selected from the group consisting of time, temperature, humidity, light level, sound level, carbon dioxide level, and ammonia level.

51. The environmental monitoring device of claim 42 further including:
one or more walls; and
one or more perforations constructed and arranged to permit air to flow into the environmental monitoring device, the one or more perforations disposed on the one or more walls.

52. The environmental monitoring device of claim 42 wherein the environmental monitoring device further includes at least one flange to facilitate suspension of the environmental monitoring device within an animal cage.

53. The environmental monitoring device of claim 42 wherein the environmental monitoring device further includes a holding attachment for positioning the environmental monitoring device within an animal cage.

54. The environmental monitoring device of claim 42 wherein the environmental monitoring device causes the one or more alerts to be sent to one or more mobile devices.

55. The environmental monitoring device of claim 42 wherein the environmental monitoring device causes the one or more alerts to be sent to one or more electronic addresses.

56. A method of monitoring a ventilated animal housing system, the method comprising:
providing a system controller device adapted and configured to monitor the ventilated animal housing system;
collecting control data relating to one or more functions of the ventilated animal housing system;
analyzing at least a portion of the collected control data in reference to one or more predetermined control parameters;
causing one or more control alerts to be sent to one or more users in the event any portion of the collected control data triggers a control alert signal based on the one or more predetermined control parameters.

57. The method of claim 56 wherein the one or more control alerts is electronically sent to one or more electronic addresses.

58. The method of claim 56 wherein the one or more control alerts is a message sent to one or more mobile devices.

59. The method of claim 56 wherein the one or more control alerts is a visual alert.

60. The method of claim 56 wherein the one or more control alerts is a audio alert.

61. The method of claim 56 further comprising:
providing an environmental monitoring device adapted and configured to detect, analyze, and report one or more environmental conditions proximate the environmental monitoring device;
collecting environmental data relating to the one or more environmental conditions;
analyzing at least a portion of the collected environmental data in reference to one or more predetermined environmental parameters;
causing one or more environment alerts to be sent to the one or more users in the event any portion of the collected environmental data triggers an environment alert signal based on the one or more predetermined environmental parameters.

62. The method of claim 61 wherein the environmental monitoring device is arranged and configured to electronically communicate with the system controller device.

63. The method of claim 56 further comprising:
providing an electronic display; and
causing the at least a portion of the control data to be selectively displayed on the display.

64. The method of claim 61 further comprising:
providing an electronic display; and
causing the at least a portion of the environmental data to be selectively displayed on the display.

65. The method of claim 56 further comprising providing a network access point, wherein the system controller device is arranged and configured to communicate with a network access point.

66. The method of claim 61 further comprising providing a network access point, wherein the environmental monitoring device is arranged and configured to communicate with a network access point.

67. The method of claim 56 wherein at least one of the one or more functions of the ventilated animal housing system is selected from the group consisting of pre-filter time, pre-filter status, fan run time, fan status, power level, filter status, air pressure, air temperature, connection status.

68. The method of claim 61 wherein at least one of the one or more environmental conditions is selected from the group consisting of time, temperature, humidity, light level, sound level, carbon dioxide level, and ammonia level.

69. A method of analyzing and reporting environmental conditions, the method comprising:
providing an environmental monitoring device adapted and configured to detect, analyze, and report one or more environmental conditions proximate the environmental monitoring device;
collecting environmental data relating to one or more environmental conditions;
analyzing at least a portion of the collected environmental data in reference to one or more predetermined environmental parameters;
causing one or more environmental alerts to be sent to one or more users in the event any portion of the collected environmental data triggers an environmental alert signal based on the one or more predetermined environmental parameters.

70. The method of claim 69 further comprising:
providing an electronic display; and
causing at least a portion of the environmental data to be selectively displayed on the display.

71. The method of claim 69 further comprising providing a network access point, wherein the environmental monitoring device is arranged and configured to communicate with the network access point.

72. The method of claim 69 wherein at least one of the one or more environmental conditions is selected from the group consisting of time, temperature, humidity, light level, sound level, carbon dioxide level, and ammonia level.

73. The method of claim 69 wherein the one or more environmental alerts is electronically sent to one or more electronic addresses.

74. The method of claim 69 wherein the one or more environmental alerts is a message sent to one or more mobile devices.

75. The method of claim 69 wherein the one or more environmental alerts is a visual alert.

76. The method of claim 69 wherein the one or more environmental alerts is a audio alert.
